(19) United States
(12) Patent Application Publication
(10) Pub. No.: US 2004/0088875 A1
(43) Pub. Date: May 13, 2004

(54) Tape measure

(76) Inventors: Choon Nam Lee, Palos Verdes Penninsula, CA (US); Kyoung Soo Choi, Pacifica, CA (US)

Correspondence Address: PARK & SUTTON LLP, 3255 WILSHIRE BLVD, SUITE 1110, LOS ANGELES, CA, 90010, US

(21) Appl. No.: 10/293,568

(22) Filed: Nov. 13, 2002

(51) Int. Cl. G01B 3/10

(52) U.S. Cl. 33/759

(57) ABSTRACT

A tape measure comprises a housing having a bottom surface and a front surface substantially perpendicular to the bottom surface. A front opening is formed through the front surface, a bottom opening is formed through the bottom surface, and a head seat is provided below the front opening to form a right angle with the bottom surface. A tape strip is elastically wound within the housing and a hook is attached to the outer end of the tape strip. A metallic plate is attached on the head seat and linearly aligned with the front surface of the housing.

### BACKGROUND OF THE INVENTION

The invention relates to a tape measure. More particularly, the present invention relates to an improved tape measure that facilitates wood board work including cutting and straight line drafting and that substantially prevents breakdown thereof by enabling internal dust or wood work debris to become externally released.

Tape measures have been widely used by both non-carpenter individuals and carpenters as an essential measurement tool. Also, a tape measure has long been regarded as a necessity to both novices and professionals in wood board work and other construction works. Although the conventional tape measure has been serving as a convenient measurement tool, its functional usability has been disregarded that would be significantly increased by adding novel concepts to the measurement focused tool.

What the market demands is a tape measure that provides reliable propping when applied to, for example, drafting a straight line on a wood board or straight cutting a plywood. Another demand is to increase product longevity by efficiently removing dust or wood work debris from inside the tape measure body.

### SUMMARY OF THE INVENTION

The present invention is contrived to overcome the conventional disadvantages. Accordingly, it is an object of the present invention to provide a tape measure that facilitates wood board work including cutting and straight line drafting by providing a reliable propping on the tape measure body.

It is another object of the present invention to provide a tape measure that externally releases dust or word work debris therefrom so as to substantially prevent product breakdown. A further object is to increase product longevity by efficiently protecting spring mechanism within the tape measure body.

To achieve the above-mentioned objects, the tape measure according to the present comprises a housing having a bottom surface and a front surface substantially perpendicular to the bottom surface. A front opening is formed through the front surface, and a bottom opening is formed through the bottom surface. A head seat is provided below the front opening to form a right angle with the bottom surface. A measuring tape strip is defined by an inner end, an outer end and a tape portion between the inner and outer ends. The tape portion together with the inner end is elastically wound within the housing to become externally released from the housing when required. A hook is attached to the outer end of the tape strip to maintain the outer end of the tape strip outside the opening. The hook comprises a vertical plate, and a rear portion extending rearward from a mid line of the vertical plate so that the rear portion is attachedly layered on the tape strip such that the outer end of the tape strip abuts on the mid line of the vertical plate. The rear portion of the hook becomes narrowed in width toward the housing. A metallic plate attached on the head seat is linearly aligned with the front surface of the housing.

The bottom opening may be preferably formed in pair. The pair openings are substantially elongated, and the substantially elongated pair openings each form a right angle with the tape strip. Alternately, the substantially elongated pair openings are parallel to each other. The metallic plate is formed of either bronze or stainless steel.

In an embodiment, a tape hold control is attached to the housing to hold or release the tape portion of the tape strip by selectively pushing the tape portion against an inner wall of the housing, and a tape hold enhancer is provided adjacent to the bottom opening and within the housing to controllably soften the holding or releasing of the tape strip. The tape hold enhancer is provided behind the bottom opening from the metallic plate and has a plurality of ridges to abuttingly layered by the tape strip. The tape hold enhancer may be formed of a rubber material.

An advantage of the present invention is that the metallic plate attached on the head seat of the housing provides a reliable propping against a side edge of a wood board when the user grips with a pencil or a cutter the housing by one hand and the hook by the other hand at the same time to draw a straight line or cutting apart the straight line on the wood board, thereby improving usability without requiring additional tools.

Another advantage is that the bottom opening formed through the bottom surface of the housing efficiently releases dust or wood work debris therethrough, thereby protecting spring and other parts within the housing and subsequently increasing product longevity. A further advantage is that the tape hold control formed of rubber material and provided within the housing serves to filter and push into the bottom opening the dust or wood work debris stuck to the tape strip, thereby increasing product reliability.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a tape measure according to the present invention;

FIG. 2 is a cross-sectional front view of the tape measure according to the present invention where the tape strip stays released; and

FIG. 3 is a cross-sectional front view of the tape measure according to the present invention where the tape strip is being wound.

### DETAILED DESCRIPTION OF THE PREFERRED EMBODIMENTS

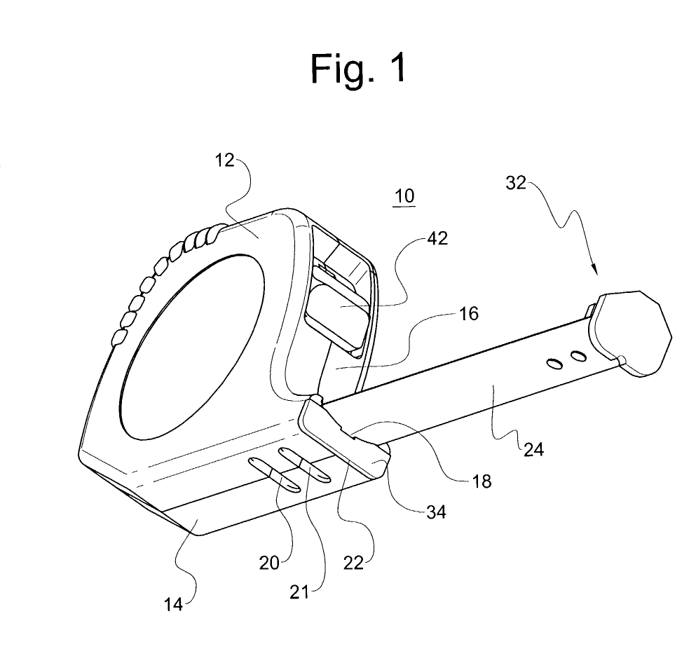

As shown in FIGS. 1, 2 and 3, a tape measure 10 according to the present invention comprises a housing 12 having a bottom surface 14 and a front surface 16. The front surface 16 is formed to become substantially perpendicular to the bottom surface 14. A front opening 18 is formed through the front surface 16, and a bottom opening 20 is formed through the bottom surface 14. In this construction, a head seat 22 is provided below the front opening 18 so that the head seat 22 forms a right angle with the bottom surface 14. Namely, the front opening 18 urges the front surface 16 to define the head seat 22 therebelow. The bottom opening 20 may be formed in pair so the pair bottom openings 20, 21 discharge dust or debris from inside the housing 12 in further efficiency.

The tape measure 10 further comprises a measuring tape strip 24 defined by an inner end 26, an outer end 28 and a tape portion 30 between the inner and outer ends 26, 28. The tape portion 30 together with the inner end 26 is elastically coiled or wound within the housing 12 to become externally released through the front opening 18 of the housing 12 when required. That is, the inner end 26 is engaged to a spring member 31 and stays coiled together with the tape portion 30 inside the housing 12 until the outer end 28 is pulled out by a user.

To implement a better performance, a hook 32 is attached to the outer end 28 of the tape strip 24 to maintain the outer end 28 of the tape strip 24 outside the front opening 18. The front opening 18 is optimally large enough to allow reciprocal movement of the tape portion 30 of the tape strip 24 therethrough whereas the front opening 18 becomes hooked by the hook 32 so as to prevent the outer end 28 of the tape strip 24 from being rewound into the housing 12 while facilitating a user to pull out the tape strip 24 grabbing the hook 32.

In an embodiment, the tape measure 10 further includes a metallic plate 34 attached on the head seat 22 of the housing 12 below the front opening 18. The metallic plate 34 is linearly aligned with the front surface 16 of the housing 12. The metallic plate 34 is preferably formed of either a bronze or a stainless steel to serve as a stable support, for example, when the tape measure 10 is used to form a straight line on a plywood or to cut apart along the straight line drawn on the plywood by abutting the metallic plate 34 on the edge of the plywood and by abuttingly moving down while holding the housing 12 by one hand and the hook 32 by the other hand at the same time.

When the bottom opening 20 is formed in pair, the pair openings 20 are substantially elongated, and the substantially elongated pair openings 20 each form a right angle with the tape strip 24. Alternately, the substantially elongated pair openings 20 may be parallel to each other to further increase efficiency in releasing dust or wood work debris from inside the housing 12 down through the bottom openings 20, thereby protecting the inner parts of the tape measure 10 including the spring member 31.

Meanwhile, the hook 32 comprises a vertical plate 36 and a rear portion 38 extending rearward from a mid line 40 of the vertical plate 36. The rear portion 38 is attachedly layered on the tape strip 24 such that the outer end 28 of the tape strip 24 abuts on the mid line 40 of the vertical plate 36. In this mechanism, when the tape strip 24 is elastically rewound into the housing 12, either the rear portion 38 or the vertical plate 36 of the hook 32 is hooked over the front opening 18 when measurement is completed. For a better performance, the rear portion 38 of the hook 32 becomes narrowed in width toward the housing 12.

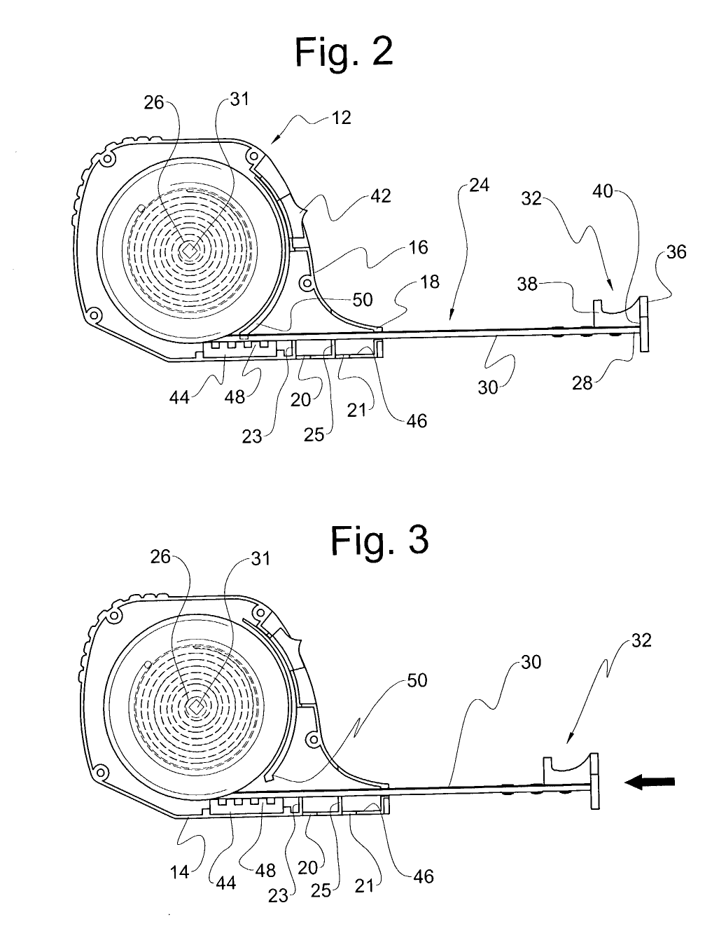

FIGS. 2 and 3 each demonstrate a switching mechanism to release or rewind the tape strip 24, the tape measure 10 further comprises a tape hold control 42 and a tape hold enhancer 44. The tape hold control 42 serving as a control switch is attached to the housing 12 to hold or release the tape portion 30 of the tape strip 24 by selectively pushing the tape portion 30 against an inner wall 46 of the housing 12.

The tape hold enhancer 44 is provided adjacent to the bottom opening 20 and within the housing 12 to controllably soften the holding or releasing of the tape strip 24. Preferably, the tape hold enhancer 44 is provided behind the bottom opening 20 from the metallic plate 34. The tape hold enhancer 44 is preferably formed of a rubber material and glued to the inner wall 46 of the housing 12. The upper surface of the tape hold enhancer 44 or rubber material has a plurality of ridges 48 to become abuttingly layered by the tape strip 24. For a better performance, dividers 23, 25 may be formed to extend upward from the inner wall 46 of the housing 12 to approach the lower surface of the tape strip 24. Here, the divider 23 is formed between the tape hold enhancer 44 and the bottom opening 20. When the opening 20 is formed in pair, the other divider 25 is formed between the bottom openings 20, 21. The dividers 23, 25 efficiently block dust or debris from coming further into the housing 12, thereby increasing longevity of the spring member 31 and maintaining the tape strip 24 in a cleaner state.

The tape hold control 42 includes a push end 50 to push the tape strip 24 against the ridges 48 of the tape hold enhancer 44 in accordance with operation of the tape hold control 42. For example, the tape hold control 42 is pushed down by the user to hold the tape strip 24 and pulled up to release the tape strip 24 for measurement operation.

As discussed above, the tape measure 10 according to the present invention is advantageous in that the metallic plate 34 attached on the head seat 22 of the housing 12 provides a reliable propping against a side edge of a wood board (not shown) when the user grips with a pencil or a cutter the housing 12 by one hand and the hook 32 by the other hand at the same time to draw a straight line or cutting apart the straight line on the wood board, thereby improving usability without requiring additional tools.

Another advantage is that the bottom opening 20 formed through the bottom surface of the housing 12 efficiently releases dust or wood work debris therethrough, thereby protecting the spring member 31 and other parts within the housing 12 and subsequently increasing product longevity. A further advantage is that the tape hold enhancer 44 formed of rubber material and provided within the housing 12 serves to filter and push into the bottom opening 20 the dust or wood work debris stuck to the tape strip 24, thereby increasing product reliability.

Although the invention has been described in considerable detail with reference to certain preferred versions thereof, other versions are possible by converting the aforementioned construction. Therefore, the scope of the invention shall not be limited by the specification specified above and the appended claims.

What is claimed is:

1. A tape measure, comprising:
a) a housing having a bottom surface and a front surface substantially perpendicular to the bottom surface, wherein a front opening is formed through the front surface, wherein a bottom opening is formed through the bottom surface, wherein a head seat is provided below the front opening to form a right angle with the bottom surface;
b) a measuring tape strip defined by an inner end, an outer end and a tape portion between the inner and outer ends, wherein the tape portion together with the inner end is elastically wound within the housing to become externally released from the housing when required;
c) a hook attached to the outer end of the tape strip to maintain the outer end of the tape strip outside the opening; and
d) a metallic plate attached on the head seat, wherein the metallic plate is linearly aligned with the front surface of the housing.

2. The tape measure of claim 1 wherein the bottom opening is formed in pair.

3. The tape measure of claim 2 wherein the pair openings are substantially elongated, wherein the substantially elongated pair openings each form a right angle with the tape strip.

4. The tape measure of claim 3 wherein the substantially elongated pair openings are parallel to each other.

5. The tape measure of claim 1 wherein the metallic plate is formed of bronze.

6. The tape measure of claim 1 wherein the metallic plate is formed of stainless steel.

7. The tape measure of claim 1 wherein the hook comprises:
a) a vertical plate;
b) a rear portion extending rearward from a mid line of the vertical plate, wherein the rear portion is attachedly layered on the tape strip such that the outer end of the tape strip abuts on the mid line of the vertical plate.

8. The tape measure of claim 7 wherein the rear portion of the hook becomes narrowed in width toward the housing.

9. The tape measure of claim 1 further comprising:
a) a tape hold control attached to the housing to hold or release the tape portion of the tape strip by selectively pushing the tape portion against an inner wall of the housing; and
b) a tape hold enhancer provided adjacent to the bottom opening and within the housing to controllably soften the holding or releasing of the tape strip.

10. The tape measure of claim 9 wherein the tape hold enhancer is provided behind the bottom opening from the metallic plate.

11. The tape measure of claim 9 wherein a divider is provided to extend from the inner wall of the housing to approach the tape strip, wherein the divider is formed between the tape hold enhancer and the bottom opening.

12. The tape measure of claim 9 wherein the tape hold enhancer is formed of a rubber material.

13. The tape measure of claim 9 wherein an upper surface of the tape hold enhancer has a plurality of ridges to become abuttingly layered by the tape strip.

14. The tape measure of claim 13 wherein the tape hold enhancer is formed of a rubber material.
